(19) United States
(12) Patent Application Publication
(10) Pub. No.: US 2020/0248616 A1
(43) Pub. Date: Aug. 6, 2020

(54) ELECTRIC MEDIA GAP MACHINE FOR A COMPRESSOR AND/OR TURBINE, COMPRESSOR AND/OR TURBINE

(71) Applicants: Robert Bosch GmbH, Stuttgart (DE); BMTS Technology GmbH & Co. KG, Stuttgart (DE)

(72) Inventors: Holger Rapp, Ditzingen (DE); Michael Nau, Dornhan/Aischfeld (DE); Thomas Frühschütz, Holzkirchen (DE); Ingo Immendoerfer, Tamm (DE); Michael Bäuerle, Eberdingen (DE); Martin Kropp, Albershausen (DE); Hartmut Weiss, Stuttgart (DE)

(21) Appl. No.: 16/648,859

(22) PCT Filed: Sep. 18, 2018
(86) PCT No.: PCT/EP2018/075212

§ 371 Date: Mar. 19, 2020

(30) Foreign Application Priority Data
Sep. 22, 2017 (DE) 10 2017 216 859.5

(51) Int. Cl. F02B 37/10; F01D 15/08

(52) U.S. Cl. CPC F02B 37/10; F05B 2220/40; F01D 15/08

(57) ABSTRACT

The invention relates to an electric media gap machine (10) for a compressor (2) and/or a turbine (3), in particular for a turbocharger (1) of an internal combustion engine, comprising a shaft (5) which is rotatably mounted in a housing (6) and to which a rotor (11) is rotationally fixed, a stator (12) which is fixed to the housing and which has at least one multiphase drive winding (16) for generating a drive magnetic field and multiple stator teeth (15) which protrude inwards radially. Each stator tooth (15) has a tooth base (29) paired with a stator yoke (12) and a free end (28) facing the rotor (11). The end (28) of at least multiple stator teeth (15), in particular of all of the stator teeth (15), is axially offset to the tooth base (29) of the same stator tooth (15).

### BACKGROUND OF THE INVENTION

The invention relates to an electric media gap machine for a compressor and/or a turbine, in particular for an exhaust-gas turbocharger of an internal combustion engine, comprising a shaft which is rotatably mounted in a housing and on which a rotor is co-rotationally arranged comprising a stator which is fixed to the housing and which has at least one multiphase drive winding for generating a drive magnetic field and multiple stator teeth which protrude radially inwards, wherein each stator tooth has a tooth base paired with a stator yoke and a free end facing the rotor.

The invention also relates to a compressor and/or a turbine, in particular an exhaust-gas turbocharger, comprising a housing and comprising a shaft which is rotatably mounted in the housing and on which at least one compressor wheel or turbine wheel is co-rotationally arranged, and comprising an electric media gap machine, which has a rotor co-rotationally arranged on the shaft and a stator which is fixed to the housing, wherein the stator has a drive winding for generating a drive magnetic field.

Electric media gap machines and compressors and/or turbines of the type mentioned at the beginning are already known from the prior art. Compressors, in particular turbochargers and exhaust-gas turbochargers, are used particularly in motor vehicle construction to increase the air filling into cylinders of the internal combustion engine, in order to increase the output of the internal combustion engine. Frequently, exhaust-gas turbochargers, which are driven by the exhaust gas stream of the internal combustion engine, are used for this purpose. Furthermore, it is known to support turbochargers with electric motors, so that, independently of an exhaust gas stream from the internal combustion engine, fresh air taken in can be compressed and fed to the internal combustion engine with an increased charging pressure. Such a turbocharger is known, for example, from the laid-open specification DE 10 2014 210 451 A1. Electric-motor support is also already known in an exhaust-gas turbocharger, in order to drive the shaft of the exhaust-gas turbocharger on which both a compressor wheel and a turbine wheel are co-rotationally arranged. In this way, for example, the buildup of the charging pressure can be accelerated considerably.

The implementation of the electric-motor support by a media gap machine has the advantage that the motor support can be integrated into the turbocharger in a particularly installation space-saving manner, since the fresh air taken in is guided through a media gap formed between rotor and stator of the media gap machine. The media gap machine can thus be integrated into the flow path in a particularly installation space-saving manner. In addition, the advantage results that rotor and stator of the media gap machine are cooled by the air stream during operation.

Usually, the stator has a stator yoke in the form of a circular ring and stator teeth which protrude radially inwards from the stator yoke and which, seen in the circumferential direction, are arranged to be distributed uniformly at a distance from one another. A multiphase drive winding is usually wound around the stator teeth, wherein, by energizing the phases of the drive winding by means of a power electronic unit provided for the purpose, a drive magnetic field rotating and acting on the rotor likewise co-rotationally arranged on the shaft is generated, by means of which the rotor and the shaft are driven with a predefinable torque. Here, the rotor usually has one or more permanent magnets, which interact with the rotating magnetic field.

### SUMMARY OF THE INVENTION

The media gap machine according to the invention has the advantage that the rotor of the media gap machine can be arranged to be offset axially relative to the stator and to the stator yoke with the same output potential of the media gap machine. As a result, the rotor can be arranged closer to at least one bearing, in particular rolling element bearing, supporting the shaft, which means that an oscillatory behavior of the rotor or of the shaft in operation is optimized or reduced. Here, it is assumed that, on the side of the compressor wheel or turbine wheel that faces away from the rotor, there is arranged at least one bearing, in particular rolling element bearing, for the rotatable mounting of the shaft in the housing, and that the rotor is in particular located on a free shaft end of the shaft. According to the invention, provision is made for this purpose for the end of at least several stator teeth, in particular all the stator teeth, to be arranged to be offset axially relative to the tooth base of the same stator tooth. The stator teeth, as seen in longitudinal section, thus do not protrude (only) radially inwards, perpendicular to the shaft axis or rotor axis, but have a curvature, bend or shear by means of which the end is arranged to be axially offset relative to the tooth base of the respective stator tooth. The rotor is preferably arranged to be opposite the bases of the stator teeth, wherein in this case the stator is arranged opposite the axially offset bases. As a result, the output of the electric media gap machine is maintained but an axial offset of the rotor relative to the stator yoke is made possible.

According to a preferred embodiment of the invention, the respective stator tooth of the at least several stator teeth has, at least in some sections, a curvature or shear for the axially offset arrangement of the end relative to the tooth base. The curvature can have a small or a large radius. Thus, according to a first embodiment, provision is made for the respective stator tooth to have in a very short section a curvature with a radius that is small, in such a way that the stator tooth virtually has a bend in the axial direction, so that, in some sections, the result is a shape of the stator tooth which is parallelogram-like. This results in a simple and economical solution. Alternatively, the curvature has a large radius in such a way that the curvature can be seen clearly on the side edges of the respective stator tooth (seen in a side view). Thus, for example, the leading edge and the trailing edge of the respective stator tooth are curved in some sections, in particular over part of the height of the respective stator tooth. Preferably, the curvature of the respective stator tooth is a bending curvature. This means that the end of the respective stator tooth is/has been offset axially relative to the tooth base by a bending process. As a result of this subsequent deformation of the stator tooth, a simple axial offset at the end relative to the tooth base is ensured. The stator can be formed from a solid element or from a multiplicity of stator laminations. In the case of a laminated embodiment, preferably each lamination is bent in a press before the individual laminations are joined together to form the stator, so that when the multiple laminations are joined together, the desired stator tooth shape with the offset end results. Only after the joining of the individual lamination parts to form the overall stator is the latter baked with baking lacquer and optionally machined in order to achieve an outer contour of the respective stator tooth that is beneficial to flow. Alternatively, the curvature of the respective stator tooth is already taken into account and provided during the production of the stator, that is to say during the shaping of the stator or the respective stator tooth. Preferably, before being put together, the stator laminations are punched out in such a way that they already have the axially offset shape of the respective stator tooth. This is correspondingly true if a shear is provided instead of the curvature.

According to a further development of the invention, provision is made for the at least several stator teeth each to have a basic tooth and a flux guide element adjoining the basic tooth. Each stator tooth is thus assembled from a basic tooth and a flux guide element adjacent thereto. By means of the flux guide elements, which are usually formed to be narrower than the basic tooth, the magnetic flux of the stator can be fed more closely to the rotor and the air gap between stator and rotor can be reduced in size, by which means the output of the media gap machine is increased.

Preferably, the curvature is formed in the transition from the basic tooth to the flux guide element. The basic tooth is thus oriented radially perpendicular to the axis of rotation of the rotor, as is usual in stator teeth, while the flux guide elements have the end forming the stator tooth, which is arranged to be offset axially relative to the basic tooth. If necessary, basic tooth and flux guide element are formed as separate components, which are joined to each other during the production of the media gap machine. As a result, it is possible to dispense with the subsequent production of the curvature. Instead, the flux guide element is already formed in a parallelogram shape and fixed to the free end of the basic tooth, so that the aforementioned shape of the respective stator tooth results when basic tooth and flux guide element are joined together.

As an alternative to the curvature being located in the transition region from basic tooth to flux guide element, according to a further preferred embodiment the curvature extends along the respective flux guide element. The respective flux guide element is thus itself curved and thus has a curved leading edge and a curved trailing edge. The curvature does not necessarily have to be located in the transition from stator tooth to the flux guide element, however, but can also be spaced apart radially from the transition from basic tooth to flux guide element, located in the basic tooth or in the flux guide piece.

According to a preferred embodiment of the invention, the offset ends of the stator teeth are offset equally far axially. As a result, the offset ends, seen axially, are located opposite one another at the same height, which results in advantageous operation of the media gap machine.

The compressor according to the invention and/or the turbine according to the invention, in particular the exhaust-gas turbocharger according to the invention is distinguished by the inventive construction of the media gap machine. In this way, the advantages already mentioned result.

In particular, the ends of the at least several stator teeth are arranged to be offset axially in the direction of the compressor wheel or turbine wheel, so that the rotor is or can be arranged closer to the compressor wheel or turbine wheel. As a result, it is possible also to arrange the rotor in a region of the housing in which the rotor is located radially within a housing section, which prevents further axial displacement of the drive winding or the stator yoke in the direction of the compressor wheel or turbine wheel. Usually, turbochargers have at least one flow volute, which is paired with the respective impeller, that is to say a compressor wheel or turbine wheel. This flow volute reduces the size of the interior of the housing and, as a result, the installation space available for the media gap machine. As a result of the advantageous construction of the compressor and/or the turbine with the media gap machine according to the invention, the rotor can be arranged axially in the region of the volute. As a result, a particularly compact arrangement is achieved, which reduces the distance of the rotor from the rolling element bearings paired with the compressor wheel or turbine wheel, so that the oscillatory behavior of the shaft at the end carrying the rotor is improved.

Furthermore, provision is preferably made for the axial length of the respective stator tooth to be constant or to change in the radial extent of the respective stator tooth. As a result, optimization of the stator geometry with respect to the existing installation space and/or the output requirements is possible.

### BRIEF DESCRIPTION OF THE DRAWINGS

The invention is to be explained in more detail below by using the drawings, in which

FIG. 1 shows an exhaust gas turbocharger with an integrated media gap machine in a simplified sectional illustration,

FIG. 2 shows a cross-sectional illustration through the media gap machine, and

FIG. 3 shows a design variant of the media gap machine in a detailed view.

### DETAILED DESCRIPTION

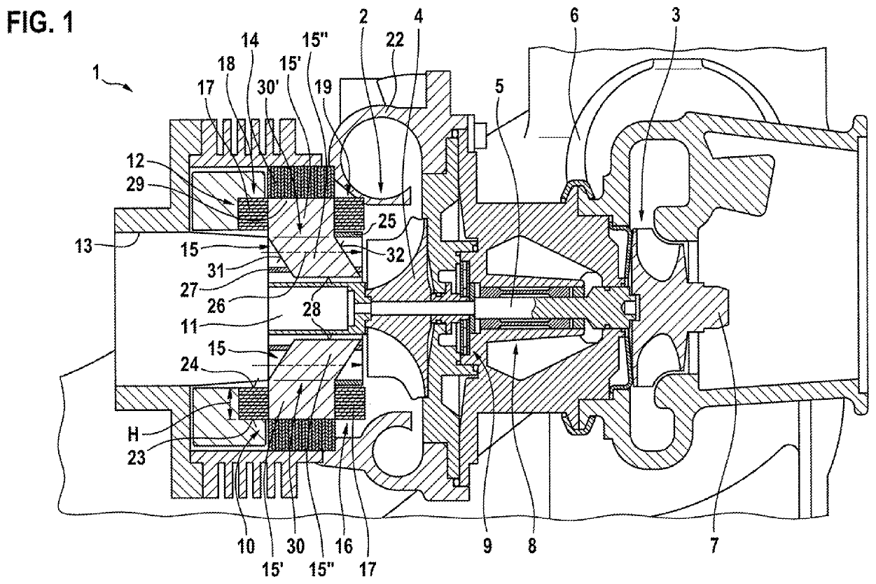

FIG. 1 shows, in a simplified longitudinal sectional illustration, an exhaust-gas turbocharger 1, which has a compressor 2 and a turbine 3. The compressor 2 has a compressor wheel 4, which is co-rotationally arranged on a shaft 5. The shaft 5 is itself rotatably mounted in a housing 6 of the exhaust-gas turbocharger 1. At an end of the shaft 5 that faces away from the compressor wheel 4, a turbine wheel 7 of the turbine 3 is additionally co-rotationally connected to the shaft 5. When exhaust gas from an internal combustion engine flows into the turbine wheel 7 and the latter is driven as a result, the compressor wheel 4 is therefore likewise set into a rotational movement, so that fresh air fed to the compressor wheel 4 is compressed and fed to the internal combustion engine.

The rotatable mounting of the shaft 5 in the housing 6 can be implemented in different ways. According to a first exemplary embodiment, provision is made for the shaft 5 to be rotatably mounted in the housing 6 by at least two bearings 8 and 9. Preferably, two rolling element bearings are present as bearings 8, 9. For the axial mounting of the shaft 5, provision can also be made for one of the rolling element bearings to be formed as an axial rolling element bearing.

Alternatively and according to the exemplary embodiment shown in FIG. 1, provision is made for the bearing 8 to be formed as a magnetic bearing and for the bearing 9, which serves as an axial bearing, to be formed as a rolling element bearing.

In order in particular that the compressor 2 can be driven independently of the exhaust gas stream from the internal combustion engine, so that a high cylinder air filling to the cylinders of the internal combustion engine can be achieved at any time, provision is additionally made in the present case for the exhaust-gas turbocharger 1 to have an electric media gap machine 10. In the present case, this is integrated into the compressor 2, a rotor 11 of the media gap machine 10 being co-rotationally arranged on the end of the shaft 5 that faces away from the turbine wheel 7. A stator 12 interacting with the rotor 11 is arranged coaxially relative to the rotor 11 and fixed to the housing in the flow channel 13 of the exhaust-gas turbocharger 1 that leads to the compressor wheel 4.

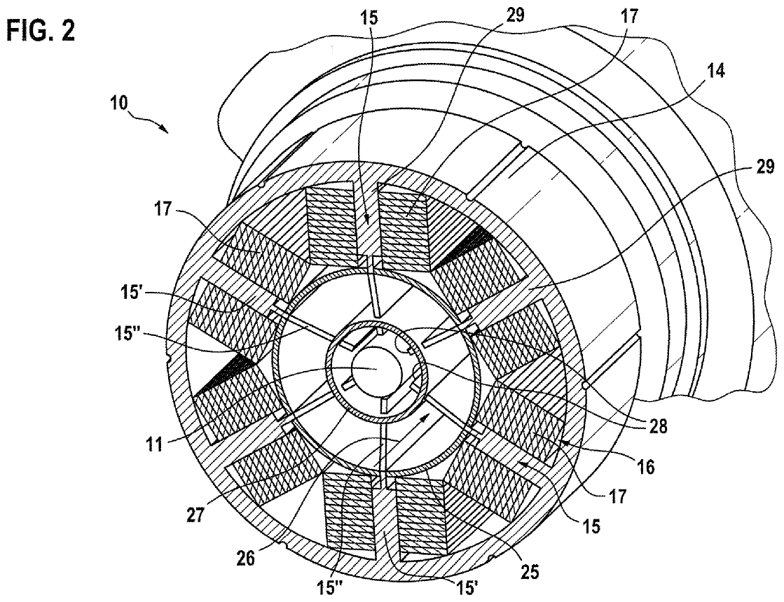

FIG. 2 shows a perspective sectional illustration of the media gap machine 10 for better understanding. The stator 12 has a circular stator yoke 14 on which a plurality of stator teeth 15 arranged uniformly over the circumference of the stator yoke 14 protrude radially inwards and point in the direction of the rotor 11 and of the axis of rotation of the shaft 5. The stator teeth 15 end radially at a distance from the rotor 12, so that an air gap remains between the stator teeth 15 and the rotor 12. In the present case, the stator teeth have a base section 15′ paired with the stator yoke 14 and a flux guide element 15″ which lengthens the base section 15′ and the free end of which is paired with the rotor 11.

The stator 12 is provided with an in particular multiphase drive winding 16, which is formed from multiple flat conductor coils 17 wound around the stator teeth 15. At the front ends of the stator 12, the flat conductor coils 17 each form a winding head 18 and 19, which projects axially beyond the stator teeth 15 and the stator yoke 14.

In the present case, the compressor 2 has a flow volute 22 paired with the impeller or compressor wheel 4. The flow volute 22 is formed by the housing 6 and projects axially beyond the compressor wheel 4 in the direction of the media gap machine 10, as shown in particular in FIG. 1. The installation space for the winding 19 in the housing 6 is delimited axially by the flow volute 22.

As shown in FIG. 2, the flat conductor coils 17 are arranged with a radial height H from an outer circumference 23 as far as an inner circumference 24, advantageously between the stator yoke 14 and an outer sleeve 25, which, radially on the outside, delimits a flow path 26 for the medium, in particular the fresh air, leading through the media gap machine 10. The outer sleeve 25 is pierced by the stator teeth 15, in particular by the flux guide elements 15″ thereof.

Coaxially relative to the outer sleeve 25, an inner sleeve 27 is arranged within the outer sleeve 25 and is paired with the rotor 11 but located at a distance from the latter. The stator teeth 15 extend with their flux guide elements 15″ at least as far as the inner sleeve 27 or penetrate the latter, so that they extend through the entire interspace between outer sleeve 25 and inner sleeve 27. The inner sleeve 27 delimits the flow path 26 radially on the inside and is preferably closed on its front side located upstream of the rotor 11 by a covering cap, so that the medium which is guided through the media gap machine 10 is guided only through the flow path 26 between inner sleeve 27 and outer sleeve 25. Because the flow path 26 is thus led through the stator 12 and the medium flows around the stator teeth 15, at least the flux guide elements 15″, the stator 12 and the rotor 11 are advantageously cooled by the medium. Optionally, the outer sleeve 25 has a corresponding number of stator teeth 15 and holding devices for holding and locking the flat conductor coils 17, so that these are/can be preassembled on the outer sleeve 25 and form a pre-assembly unit together with the outer sleeve 25. Optionally, the inner sleeve 27 is additionally connected to the outer sleeve 25, in particular formed in one piece with the latter, in order to form a compact unit or pre-assembly group. In particular, for example, radial webs are provided between the inner sleeve 27 and the outer sleeve 25, by means of which the one-piece formation is ensured. The radial webs are in particular formed in such a way as to accommodate one of the flux conductor elements 15″ each and to surround the latter, so that a compact and simple arrangement and orientation of the pre-assembly unit on the stator 12 is achieved.

As can be seen in FIG. 1, the flux guide elements 15″ are formed in the shape of a parallelogram by a shear 30′, so that an end 28 of the respective stator tooth 15 that faces the rotor 11 is offset axially relative to the stator yoke 14 and to a tooth base 29 of the respective stator tooth 15 that faces the stator yoke. In the present case, all stator teeth 15 are formed in a corresponding way, so that the ends 28 of the stator teeth 15 are offset axially with respect to the stator yoke 14 in the direction of the compressor wheel 4. As a result, the rotor 11 is arranged axially particularly close to the compressor wheel 4 on the shaft 5, so that the distance of the rotor 11 from the bearing 8 is shortened. Therefore, the oscillatory behavior of the shaft 5 at the end having the rotor 11 is improved, and the operating behavior of the exhaust-gas turbocharger 1 is optimized overall.

According to the present exemplary embodiment, because of the parallelogram-like configuration of the flux guide elements 15″, a virtually abrupt transition between the non-sheared region in the basic teeth 15′ and the sheared region in the flux guide elements 15″ is formed, which in this transition represents a curvature of the respective stator teeth 15 with a very small radius, which leads to the ends 28 being arranged and aligned to be offset axially relative to the tooth bases 29. In other words, the stator teeth 15 are sheared in the direction of the compressor wheel 4, starting from the transition from basic tooth 15′ to flux guide element 15″.

In a laminated design of the stator 12, this is achieved in particular in that each stator lamination is bent in a press before the joining of the individual stator laminations to form the stator 12 or to form a stator tooth 15. The bending is carried out in the present exemplary embodiment in such a way that each stator lamination is bent or angled over in the region of the flux guide piece 15″ in accordance with the virtually abrupt transition. After that, the joining to form an overall stator tooth 15 with yoke part and stator yoke 14 and flux guide piece 15″ is carried out. Alternatively, the stator lamination pack can also be joined from still un-bent or not angled-over laminations, and the bending or turning over can then be carried out on the entire lamination pack. Baking with baking lacquer and repeated machining, in which the respective flux guide piece is given a final outer contour benefiting flow, is preferably carried out subsequently.

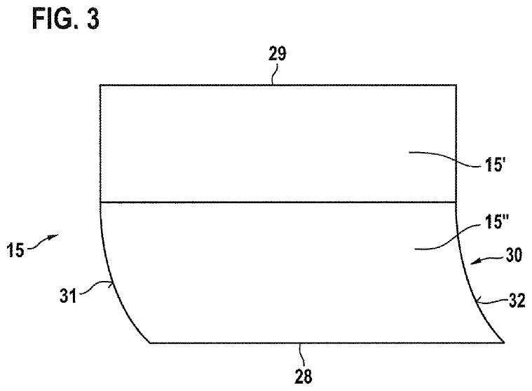

FIG. 3 shows a further exemplary embodiment of the media gap machine by using a detailed view of one of the stator teeth 15. As an alternative to the previously described exemplary embodiment, instead of the shear 30′, a curvature 30 is provided, which extends along the flux guide element 15″. While, in the preceding exemplary embodiment, there is a bend in the transition region, according to the present exemplary embodiment a bending line with the curvature 30 is provided, which has a considerably greater constant or variable radius and which extends along the entire flux guide piece 15″. As a result, a leading edge 31 that faces away from the compressor wheel 4 and a trailing edge 32 of the flux guide element 15″ that faces the compressor wheel 4 are formed so as to be curved, as can be seen in FIG. 3.

It transpires that, as a result of both variants described, the rotor 11 can be arranged closer to the compressor wheel 4 and therefore to the closest bearing 8. As a result, the risk of the occurrence of flexural oscillation, which could lead to overloading or overstressing of rotor 11 and/or shaft 5, is reduced considerably.

As an alternative to the design of the stator 12 from multiple stator laminations, according to a further exemplary embodiment provision is made for the stator 12 or the stator teeth 15 to be made from solid material or from a powder composite material. In this case, it would also be possible to make geometries in which the axial length of the respective stator tooth in its radial extent is not constant but varies. In this way, for example, optimal adaptation of the respective stator tooth to the existing installation space can be achieved.

The start of the shear or of the curvature does not necessarily have to be located at the transition between the basic tooth 15′ and flux guide element 15″ as in the present exemplary embodiments, but can also be located radially at a distance from this transition within the basic tooth 15′ or the flux guide element 15″.

1-10. (canceled)

11. A compressor (2) and/or turbine (3) comprising
a housing (6),
a shaft (5) which is rotatably mounted in the housing (6) and on which at least one compressor wheel (4) or turbine wheel (7) is co-rotationally arranged, and
comprising an electric media gap machine (10) having a rotor (11) co-rotationally arranged on the shaft (5) and a stator (12) fixed to the housing, the stator having at least one multiphase drive winding (16) for generating a drive magnetic field, and multiple stator teeth (15) which protrude radially inwards, wherein each stator tooth (15) has a tooth base (29) paired with a stator yoke (12) and a free end (28) facing the rotor (11), wherein the free ends (28) of at least several stator teeth (15) are arranged to be offset axially relative to the tooth base (29) of the same stator tooth (15),
wherein the free ends (28) of the at least several stator teeth (15) are arranged to be offset axially in a direction of the compressor wheel (4) or the turbine wheel (7).

12. The compressor and/or turbine as claimed in claim 11, wherein each respective stator tooth (15) of the at least several stator teeth (15) has, at least in some sections, a curvature (30) for the axially offset arrangement of the end (28) relative to the tooth base (29).

13. The compressor and/or turbine as claimed in claim 11, wherein each respective stator tooth (15) of the at least several stator teeth (15) has, at least in some sections, a shear (30′) for the axially offset arrangement of the end (28) relative to the tooth base (29).

14. The compressor and/or turbine as claimed in claim 11, wherein the at least several stator teeth (15) each have a basic tooth (15′) and a flux guide element (15″) adjoining the basic tooth (15′).

15. The compressor and/or turbine as claimed in claim 14, wherein each respective stator tooth (15) of the at least several stator teeth (15) has, at least in some sections, a curvature (30) for the axially offset arrangement of the end (28) relative to the tooth base (29), and wherein the curvature (30) is formed in the transition from the basic tooth (15′) to the flux guide element (15″), in the basic tooth (15′) or in the flux guide element (15″).

16. The compressor and/or turbine as claimed in claim 14, wherein the curvature (30) of the respective stator tooth (15) extends along the respective flux guide element (15″).

17. The compressor and/or turbine as claimed in claim 11, wherein the offset ends (28) of the stator teeth (15) are offset equally far axially.

18. The compressor and/or turbine as claimed in claim 11, wherein an axial length of the at least several stator teeth (15) is constant or changes in a radial extent of the respective stator tooth (15).

19. An exhaust-gas turbocharger (1), comprising
a housing (6),
a shaft (5) which is rotatably mounted in the housing (6) and on which at least one compressor wheel (4) or turbine wheel (7) is co-rotationally arranged, and
comprising an electric media gap machine (10) having a rotor (11) co-rotationally arranged on the shaft (5) and a stator (12) fixed to the housing, the stator having at least one multiphase drive winding (16) for generating a drive magnetic field, and multiple stator teeth (15) which protrude radially inwards, wherein each stator tooth (15) has a tooth base (29) paired with a stator yoke (12) and a free end (28) facing the rotor (11), wherein the free ends (28) of all the stator teeth (15) are arranged to be offset axially relative to the tooth base (29) of the same stator tooth (15),
wherein the free ends (28) of the at least several stator teeth (15) are arranged to be offset axially in a direction of the compressor wheel (4) or the turbine wheel (7).

20. The exhaust-gas turbocharger as claimed in claim 19, wherein each respective stator tooth (15) of the at least several stator teeth (15) has, at least in some sections, a curvature (30) for the axially offset arrangement of the end (28) relative to the tooth base (29).

21. The exhaust-gas turbocharger as claimed in claim 19, wherein each respective stator tooth (15) of the at least several stator teeth (15) has, at least in some sections, a shear (30′) for the axially offset arrangement of the end (28) relative to the tooth base (29).

22. The exhaust-gas turbocharger as claimed in claim 19, wherein the at least several stator teeth (15) each have a basic tooth (15′) and a flux guide element (15″) adjoining the basic tooth (15′).

23. The exhaust-gas turbocharger as claimed in claim 22, wherein each respective stator tooth (15) of the at least several stator teeth (15) has, at least in some sections, a curvature (30) for the axially offset arrangement of the end (28) relative to the tooth base (29), and wherein the curvature (30) is formed in the transition from the basic tooth (15′) to the flux guide element (15″), in the basic tooth (15′) or in the flux guide element (15″).

24. The exhaust-gas turbocharger as claimed in claim 22, wherein the curvature (30) of the respective stator tooth (15) extends along the respective flux guide element (15″).

25. The exhaust-gas turbocharger as claimed in claim 19, wherein the offset ends (28) of the stator teeth (15) are offset equally far axially.

26. The exhaust-gas turbocharger as claimed in claim 19, wherein an axial length of the at least several stator teeth (15) is constant or changes in a radial extent of the respective stator tooth (15).
